(19) United States
(12) Patent Application Publication
(10) Pub. No.: US 2017/0108851 A1
(43) Pub. Date: Apr. 20, 2017

(54) INDUSTRIAL AUTOMATION ELECTRONIC PINBOARD

(71) Applicant: Rockwell Automation Technologies, Inc., Mayfield Heights, OH (US)

(72) Inventors: Marek Krokiewicz, Katowice (PL); Ashish Anand, Mayfield Heights, OH (US); Matthew R. Ericsson, Lyndhurst, OH (US); Douglas Reichard, Fairview Park, OH (US); Michael J. Anthony, Milwaukee, WI (US); Mohit Singhai, Lyndhurst, OH (US); Ryan Cahalane, Chagrin Falls, OH (US); Kyle Reissner, Hudson, OH (US)

(21) Appl. No.: 14/882,657

(22) Filed: Oct. 14, 2015

(51) Int. Cl. G05B 19/418; G06F 3/0484; G06F 3/0481

(52) U.S. Cl. CPC G05B 19/418; G06F 3/04817; G06F 3/04842; G05B 2219/32128

(57) ABSTRACT

Techniques to facilitate pinning information in an industrial automation environment are disclosed herein. In at least one implementation, a pinboard associated with an asset of the industrial automation environment is displayed on a display system of a computing system, wherein the pinboard includes a plurality of entries comprising content associated with the asset. A user request is received to add a new entry to the pinboard comprising additional content associated with the asset. The user request is transferred to an application server, wherein the application server processes the user request to add the new entry to the pinboard.

### TECHNICAL FIELD

Aspects of the disclosure are related to computing hardware and software technology.

### TECHNICAL BACKGROUND

Software applications that run on computing systems commonly provide some type of user client interface to present information to the user and receive user inputs. In a typical client-server architecture, an application running on a client computing system receives data transmitted from a server over a communication network for display to the user on the user client interface.

Industrial automation environments utilize machines during the industrial manufacturing process. These machines typically have various moving parts and other components that continually produce operational data over time, such as pressure, temperature, speed, and other metrics. Reviewing and monitoring this operational data is of high importance to those involved in operating an industrial enterprise.

In traditional implementations, the operational data may be provided for display on a variety of systems and devices, such as notebook or tablet computers running standalone applications, web browsers, and the like, in order to present the information to the user. For example, a tablet computer could receive a constant stream of the operational data over a network and display this information dynamically, such as by providing live tiles, icons, charts, trends, and other graphical representations which continually receive updated operational data from external data sources, which are typically located in the industrial automation environment.

### Overview

Techniques to facilitate pinning information in an industrial automation environment are disclosed herein. In at least one implementation, a pinboard associated with an asset of the industrial automation environment is displayed on a display system of a computing system, wherein the pinboard includes a plurality of entries comprising content associated with the asset. A user request is received to add a new entry to the pinboard comprising additional content associated with the asset. The user request is transferred to an application server, wherein the application server processes the user request to add the new entry to the pinboard.

This Overview is provided to introduce a selection of concepts in a simplified form that are further described below in the Detailed Description. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a block diagram that illustrates an operation of a communication system in an exemplary implementation.

FIG. 2 is a flow diagram that illustrates an operation of a computing system in an exemplary implementation.

FIG. 3 is a block diagram that illustrates an operational scenario of a computing system in an exemplary implementation.

FIG. 4 is a block diagram that illustrates an operational scenario of a computing system in an exemplary implementation.

FIG. 5 is a block diagram that illustrates an operational scenario involving a computing system in an industrial automation environment in an exemplary implementation.

FIG. 6 is a block diagram that illustrates a computing system in an exemplary implementation.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

In an industrial automation environment, investigation is primarily dependent on available plant-wide information, which is typically accessible over a network of machines and other equipment. For example, technicians and other users commonly review tag data, trends, alarms, documentation, incident reports, chat transcripts, screen captures, and other content that is generated during the course of operating an industrial enterprise. However, much of this information is not consolidated or readily accessible and requires individual searches and piecemeal acquisition to collect the desired data for research and analysis. The techniques disclosed herein provide for capturing and recording industrial data in an organized fashion on a virtual electronic pinboard so that selected, relevant information is easily available in the context of a machine, control system, or some other asset in an industrial environment.

In at least one implementation, a user operates a computing system such as a smartphone, tablet, or laptop to access a pinboard associated with an asset of an industrial automation environment. In some examples, the user could access the pinboard by manually selecting the pinboard for viewing on the computing system, or the user could simply approach an asset and its pinboard could be automatically loaded by the computing system upon identifying the asset by a beacon transmission, radio frequency identification (RFID), barcode scan, or any other identification technique. Pinboard content is then received from an application server for display within the pinboard. The pinboard content typically comprises data items and other pinboard entries associated with the asset. The computing system then displays the pinboard content within the pinboard on a display system for viewing by the user. The user can select from the various data items appearing on the pinboard to access more detailed views of the pinboard content, and can also submit requests to add additional content associated with the asset to the pinboard. The user requests to add additional content are then transferred to the application server, and the application server processes the user requests to add the additional content associated with the asset to the pinboard. In this manner, the pinboard for the asset contains all relevant information and data associated with the asset in an organized and easily accessible format.

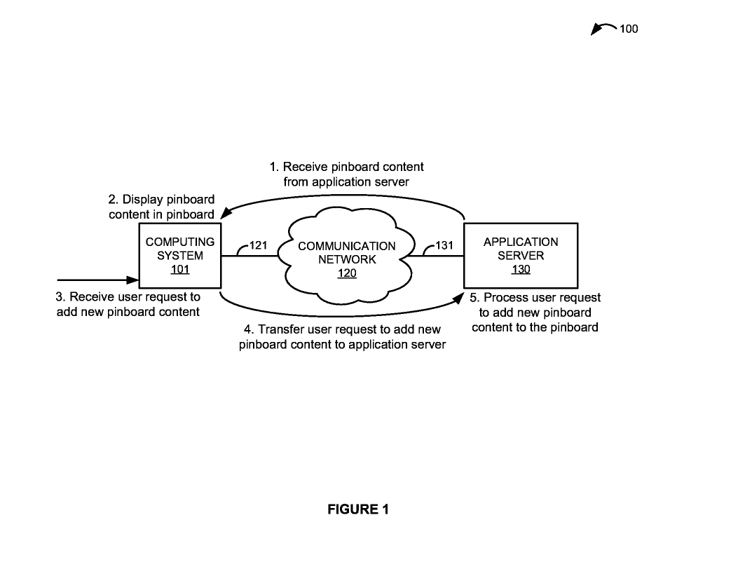

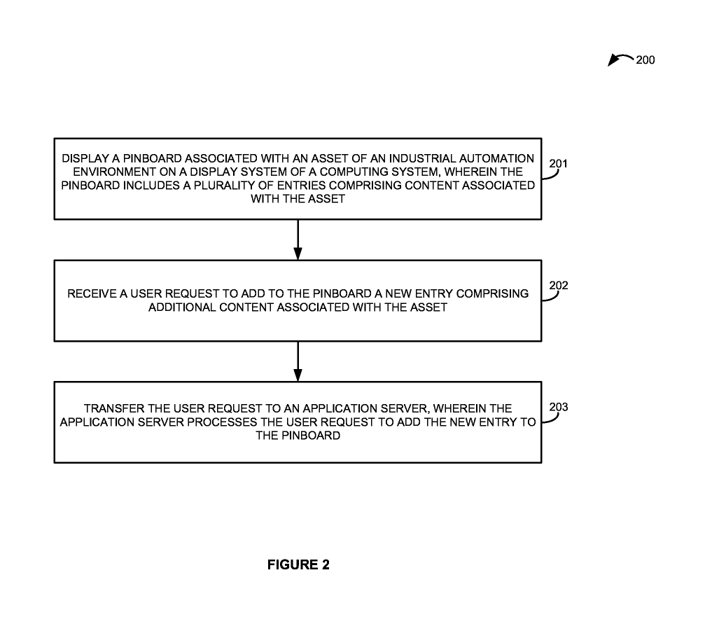

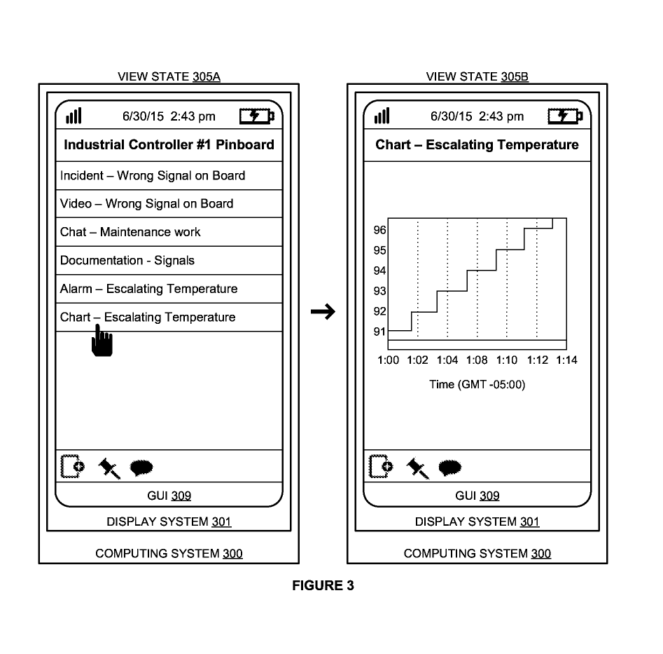

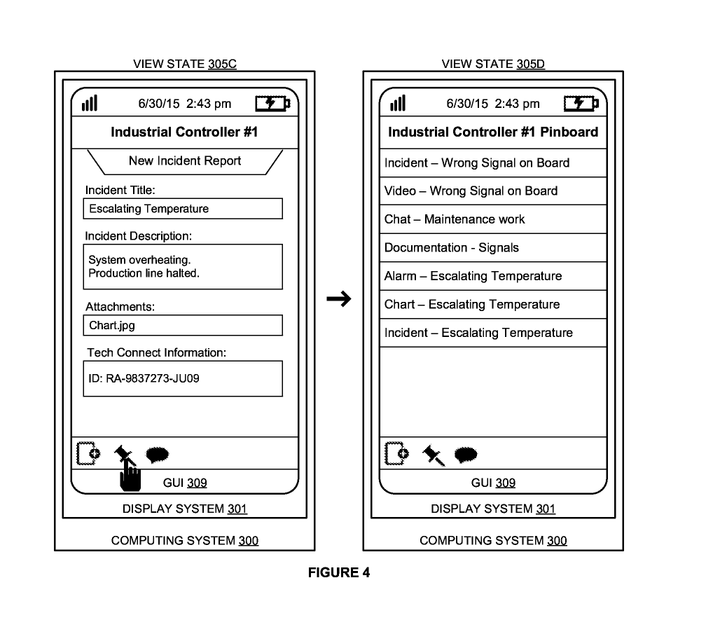

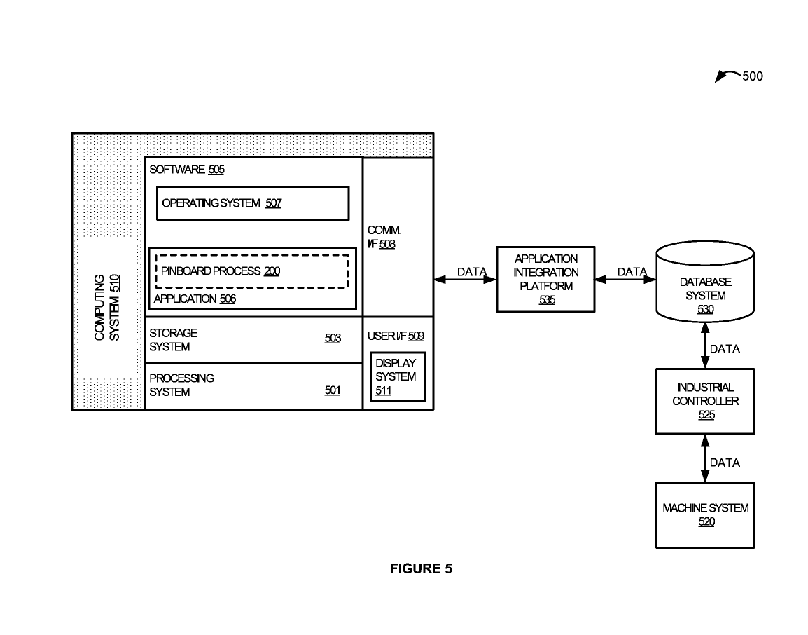

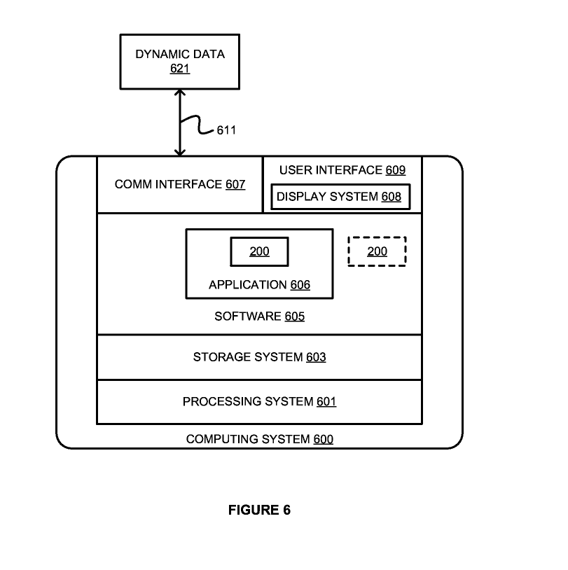

Referring now to the drawings, FIG. 1 illustrates a communication system and an operational scenario in which a computing system displays pinboard content associated with an asset and receives a user request to add new pinboard content to the pinboard. FIG. 2 illustrates a pinboard process that may be performed by a computing system. FIG. 3 illustrates an operational scenario involving a computing system in an exemplary implementation that displays a pinboard and processes a user request to display a more detailed view of a pinboard entry, while FIG. 4 illustrates an operational scenario involving a computing system that processes a user request to add a new pinboard entry to the pinboard. FIG. 5 illustrates an exemplary industrial automation environment that includes a computing system that may be used to execute a pinboard process, and FIG. 6 illustrates an exemplary computing system that may be used to perform any of the pinboard processes and operational scenarios described herein.

Turning now to FIG. 1, an operational scenario of communication system 100 is illustrated in an exemplary implementation. Communication system 100 includes computing system 101, communication network 120, and application server 130. Computing system 101 and communication network 120 communicate over communication link 121, while communication network 120 and application server 130 are in communication over communication link 131. In some examples, communication network 120 could comprise an on-premise private network or private cloud accessible over a local network connection, a public cloud-based environment accessible over a wide area network such as the Internet, or any other deployment scheme, including combinations thereof.

An exemplary operation of communication system 100 is illustrated in FIG. 1, the order of which is designated by the numerals 1 through 5, but note that the steps could be performed in any order for any operation described herein. Initially, a user accesses a pinboard for an asset on computing system 101. Pinboard content associated with the asset is then received from application server 130. Computing system 101 then displays the pinboard content for the asset within the pinboard for viewing by the user. Accordingly, the user is presented with the most important and relevant information for this asset on the pinboard.

After browsing the data entries associated with the asset, the user enters a request to add new pinboard content to the pinboard. For example, the user may desire to add an operational manual for the asset or some other data item to the pinboard. Computing system 101 transfers the user request to add the new pinboard content to application server 130. Upon receipt, application server 130 processes the request to add the new pinboard content associated with the asset to the asset's pinboard. As a result, any authorized user who accesses the pinboard for this asset in the future will see the newly added pinboard content among the previously existing content. An exemplary operation of computing system 101 will now be described in greater detail with respect to FIG. 2.

FIG. 2 is a flow diagram that illustrates an operation 200 of a computing system in an exemplary implementation. The operation 200 shown in FIG. 2 may also be referred to as pinboard process 200 herein. The steps of the operation are indicated below parenthetically. The following discussion of operation 200 will proceed with reference to computing system 101 and application server 130 of FIG. 1 in order to illustrate its operations, but note that the details provided in FIG. 1 are merely exemplary and not intended to limit the scope of process 200 to the specific implementation shown in FIG. 1.

Operation 200 may be employed to operate a computing system to facilitate pinning information in an industrial automation environment. As shown in the operational flow of process 200, computing system 101 displays a pinboard associated with an asset of the industrial automation environment on a display system of computing system 101 (201). The pinboard includes a plurality of entries comprising content associated with the asset (201). The asset that is associated with the pinboard could comprise any machine or group of machines, industrial controller or controllers, department or area of a facility, team of people responsible for an area of a facility, work shift, materials, resources, or any other aspect of an industrial environment. The plurality of entries comprising the content associated with the asset could comprise operational data, machine data, images, screen graphics data, screen captures, video data, sound recordings, tag data, alarms, notifications, drive configurations, key performance indicators (KPIs), charts, trends, and other graphical content, simulation data, links to documentation, electrical drawings, manuals, material safety data sheets, standard operating procedures, emergency procedures, cleanout procedures, reset procedures, safety procedures, incident reports including problems and solutions, chat transcripts, and any other information associated with the asset of the industrial environment. The content of the plurality of entries could also include a number of machine stops in a day or during a work shift, summary of overall equipment effectiveness (OEE), summary of key performance indicators, number of users who connected to the asset in a work shift or some other period, modifications to a configuration of the asset, customized reports, and any other statistics or related data associated with the asset.

The plurality of entries comprising the content associated with the asset could be displayed within the pinboard in several ways. For example, the entries could be listed chronologically by date, in an order manually selected by the user, based on user preferences, in order of severity or relevance, based on user votes or favorites, frequency of use, level of user interest, weighting based on data category, or based on any other factors. When displaying the pinboard with the plurality of entries comprising the content associated with the asset, computing system 101 could filter the entries comprising the content associated with the asset by a category related to data types, worker roles, or any other categorization. For example, if the user is a maintenance worker operating computing system 101 within the context of an asset, the worker could filter pins appearing on the pinboard by a “maintenance” category. In this manner, only pins related to the “maintenance” category would appear in the pinboard, thereby providing the maintenance worker with quicker access to the relevant information for the maintenance work on the asset.

Application server 130 typically collects and stores the data items for the pinboard content and retrieves and transfers the data items to computing system 101, but note that the pinboard content could be received by computing system 101 for display in the pinboard from various different systems which may be in geographically diverse locations. In some examples, application server 130 could comprise a system located on-premise and accessible over a local network connection, or running in a cloud-based environment accessed over a wide area network such as the Internet, or any other deployment scheme, including combinations thereof. In some implementations, application server 130 or at least its functionality could be included within computing system 101, so that establishing a network connection to reach server 130 would be unnecessary. Other system and network architectures are possible and within the scope of this disclosure. By displaying the pinboard content within the pinboard on a display system of computing system 101, the user is able to browse and edit selected, relevant information associated with the asset on the pinboard.

Computing system 101 receives a user request to add to the pinboard a new entry comprising additional content associated with the asset (202). Typically, the user request comprises a user selection of the additional content associated with the asset that the user desires to add as a new entry to the pinboard. The additional content could comprise any of the data items described above or any other content or information associated with the asset. However, in some examples, the user request to add the new entry to the pinboard could comprise a request to automatically add the new entry comprising the additional content to the pinboard upon an occurrence of an alarm, alert, notification, or some other event trigger associated with the asset.

Computing system 101 typically provides the user with a graphical user interface (GUI) to view and interact with graphical content and other data displayed by computing system 101. In at least one implementation, a pin option could be displayed on the GUI to allow the user to request pinning of additional content associated with the asset to the asset's pinboard. The pin option may function in several ways. In some implementations, the pin option could provide a mechanism to store or “pin” to the pinboard some or all of the asset's data items presently displayed by computing system 101 when the pin option is selected. In other examples, the user could also specify the data for pinning, or the data could be predetermined and pinned automatically, or identified in some other way.

Computing system 101 transfers the user request to application server 130, wherein application server 130 processes the user request to add the additional content to the pinboard (203). Typically, to add the additional content to the asset's pinboard, application server 130 would store the additional content selected for pinning in a database and add a link to that data to the pinboard. The link to the newly added content could describe the data so that when a user accesses the pinboard in the future, the description of the content would be visible and the details and actual data of the content could be presented to the user upon selection of the link. In at the least one implementation, the user request to add the additional content to the pinboard could include instructions specifying where in the pinboard to insert the additional content among the other pinned data items, such as chronologically, always on top, at the bottom of the list, or any other insertion point.

In some implementations, the user request to add to the pinboard the new entry comprising the additional content associated with the asset comprises instructions to assign security permissions to the new entry comprising the additional content. In this case, application server 130 would process the instructions to assign the security permissions to the new entry in the pinboard. The security permissions could specify different access levels, such as read-only access, read-write access, and the like, along with different individuals or groups of individuals who are permitted to view the additional content on the pinboard. For example, individuals belonging to an administrator or supervisor worker role may receive read-write access, those belonging to a technician worker role might receive read-only access, and any other worker role may not receive access to view the additional content on the pinboard. In at least one implementation, anyone who does not have permission to view the additional content on the pinboard would be presented with the other pins when accessing the pinboard for this asset, but would not be able to see the additional content on the pinboard.

In some implementations, computing system 101 could store the new entry comprising the additional content locally in a local storage system of computing system 101. In this case, responsive to a request to view the additional content when computing system 101 is not in communication with application server 130, computing system 101 could retrieve the additional content from the local storage system and display the additional content on the display system. Computing system 101 therefore effectively caches the data locally to ensure its availability even when computing system 101 has little or no network connectivity or is otherwise not in communication with application server 130. In some examples, computing system 101 could display a list of pinned data items from which the user may select to view, delete, and otherwise manage the pinned data. In at least one implementation, computing system 101 could be configured to take snapshots of the additional content by periodically storing the additional content automatically in the local storage system. Computing system 101 could also be instructed to store the additional content in the local storage system for a time period, such as in response to a storage preference provided by the user, or based on term limits for offline data storage that apply universally to all data and/or users or that vary between different data types, users, worker roles, and other factors. After expiration of the time period, computing system 101 would automatically delete the additional content from the local storage system in some implementations.

In at least one implementation, an administrator, supervisor, or some other user could define pinboard patterns or templates that are associated with a particular asset type or types, but could also be associated with all types in some examples. The asset type could be defined as a broad category of assets such as a machine, industrial controller, department or area of a facility, work shift, and the like, or could be defined more narrowly as a particular type of machine, control system or other asset, such as a drill, pump, extruder, robot, or any other type of equipment used in an industrial environment. The template for the pinboard for a particular asset type could include drive configurations, tag data, charts, trends, and other graphical data, links to relevant documentation, electrical drawings, manuals, material safety data sheets, standard operating procedures, emergency procedures, cleanout procedures, reset procedures, safety procedures, and any other information associated with the asset type. Once a pinboard pattern is defined for a particular asset type, all pinboards associated with assets of that type will present pinned data items according to the pinboard pattern of that type, but each individual asset's pinboard could still be extended with additional pins for a customized pinboard presentation.

Advantageously, a user can operate computing system 101 to display a pinboard associated with an asset of an industrial automation environment. The user can then browse through the entries in the asset's pinboard to view relevant content associated with the asset. Additionally, the user can request to add new entries to the pinboard to include additional content associated with the asset. By providing a pinboard within the context of a particular asset, the user is presented with the most important contextual information regarding that asset, thereby reducing the time needed to extract and review the relevant data for the asset. An example of a user interacting with a pinboard presented on a graphical user interface that illustrates one possible implementation of the techniques disclosed herein will now be discussed with respect to FIG. 3.

FIG. 3 is a block diagram that illustrates an operational scenario of computing system 300 in an exemplary implementation. Computing system 300 includes display system 301 which displays graphical user interface (GUI) 309. In this example, display system 301 comprises a touch screen that displays GUI 309 for the user to interact with and accepts input commands from the user via the user's touches on the surface of the touch screen. In FIG. 3, two different view states are shown displayed on display system 301, labeled 305A and 305B. The different view states show the changes that occur to GUI 309 as the user makes selections and interacts with GUI 309.

In view state 305A, the user is presented with a pinboard for an asset, labeled “Industrial Controller #1” in this example. The pinboard could appear on display system 301 in response to a user selection to open the pinboard in some implementations. Additionally or alternatively, the “Industrial Controller #1” asset could be equipped with an RFID tag or some other wireless beacon which informs computing system 300 of the existence of the pinboard for this asset. In this case, computing system 300 might inform the user of the availability of the pinboard for this asset, and prompt the user for permission to open the pinboard for display on display system 301. Computing system 300 may also automatically open the pinboard within a certain predefined proximity threshold to the asset in some implementations.

Once the pinboard for the industrial controller asset is loaded and displayed on display system 301, a summary of data items associated with the asset is displayed in a list on the pinboard. In this example, the data items include an incident and video content related to a “Wrong Signal on Board” event, a chat session related to maintenance work, documentation on signals associated with the controller, and an alarm and chart diagram related to an “Escalating Temperature” event. These pinboard entries could have been pinned to the controller's pinboard by various users or automatically in some cases, such as in response to the alarm event. The user can select from among the various data items appearing on the pinboard to view additional details of each entry. In view state 305A, the user selects to view the chart related to the “Escalating Temperature” event, as represented by the hand icon appearing over this pinboard entry.

View state 305B illustrates an exemplary chart diagram that may appear on display system 301 in response to the user selecting the chart data item from the pinboard summary shown in view state 305A. The chart shows the details of the “Escalating Temperature” event associated with the “Industrial Controller #1” asset. In particular, the chart indicates that the temperature has steadily risen over time, which has triggered the “Escalating Temperature” alarm. The pinboard allows the user to quickly identify the problem and view the details of the alarm event, thereby enabling the user to take the necessary action to address the problem, saving valuable time and preventing potential damage to industrial equipment while minimizing the impact on production output. An exemplary implementation of a user pinning a new data item to the pinboard will now be discussed with respect to FIG. 4.

FIG. 4 is a block diagram that illustrates another operational scenario of computing system 300 in an exemplary implementation. In FIG. 4, two more view states are shown displayed on display system 301, labeled 305C and 305D. The different view states show the changes that occur to GUI 309 as the user makes selections and interacts with GUI 309.

In view state 305C, the user has created a new incident report with respect to the “Industrial Controller #1” asset. The incident report relates to a problem or issue with industrial operations. In this case, the user has specified the title of the incident as “Escalating Temperature” and has entered a description of the incident as “System overheating. Production line halted.” The user has also included an image attachment to the incident report of a screen capture of the chart depicting the escalating temperature as shown in view state 305B of FIG. 3. The “Tech Connect Information” section indicates an identifier associated with the user creating the incident report, which helps identify the user to a support service or some other system.

At the bottom of GUI 309 in view state 305C, the user is presented with a data pinning option to add the incident report as an entry on the pinboard for the “Industrial Controller #1” asset, which is represented by the pushpin icon in this example. The user selects the data pinning option by touching the pushpin icon, as represented by the small hand icon appearing in view state 305C.

In view state 305D, the user is again presented with the pinboard for the “Industrial Controller #1” asset. The pinboard could appear on display system 301 in response to the user selecting to pin the new incident report to the pinboard as depicted in view state 305C. The pinboard lists a summary data items associated with the asset. Notably, the newly added incident report now appears on the pinboard below the “Alarm” and “Chart” data items related to the “Escalating Temperature” event. Note that although the “Incident” entry appears at the bottom of the list of entries on the pinboard in this example, newly added entries could be inserted at any point on the pinboard in other examples, and even re-ordered based on user preferences, age of entry, frequency of use, or other settings and considerations. Further, in some implementations the entries could be grouped based on event occurrence, event type, data type, or other factors. In any event, the user is now able to view the important data related to the “Industrial Controller #1” asset, including the newly added incident report, thereby providing a convenient and consolidated data reference and empowering the user to review key information and quickly resolve issues when working in the context of this asset.

In some implementations, in addition to asset-specific pinboards, a pinboard could be created with respect to an individual user. The user could then pin any data items to the pinboard desired by the user, regardless of what asset or assets the data items are related. Typically, the user would pin data items to the user-specific pinboard that are associated with the assets that the user regularly works with, but the user could add any entries to the pinboard related to data generated through the operation of the industrial automation environment. The user-specific pinboard would typically be associated with a user account or user login which prevents other users from viewing the user's pinboard, but the user could set permissions to share some or all of the entries in the user's pinboard with other users in some implementations. Advantageously, the user-specific pinboard enables personalized record keeping, mixes manual and device-generated data, can be accessed at any time by the user, and is portable across any user devices based on its association with the user's profile.

Referring back to FIG. 1, computing system 101 comprises a processing system and communication transceiver. Computing system 101 may also include other components such as a user interface, data storage system, and power supply. Computing system 101 may reside in a single device or may be distributed across multiple devices. Examples of computing system 101 include mobile computing devices, such as cell phones, tablet computers, laptop computers, notebook computers, and gaming devices, as well as any other type of mobile computing devices and any combination or variation thereof. Examples of computing system 101 also include desktop computers, server computers, and virtual machines, as well as any other type of computing system, variation, or combination thereof. In some implementations, computing system 101 could comprise a mobile device capable of operating in a server-like fashion which, among other uses, could be utilized in a wireless mesh network.

Communication network 120 could comprise multiple network elements such as routers, gateways, telecommunication switches, servers, processing systems, or other communication equipment and systems for providing communication and data services. In some examples, communication network 120 could comprise wireless communication nodes, telephony switches, Internet routers, network gateways, computer systems, communication links, or some other type of communication equipment, including combinations thereof. Communication network 120 may also comprise optical networks, asynchronous transfer mode (ATM) networks, packet networks, wireless mesh networks (WMN), local area networks (LAN), metropolitan area networks (MAN), wide area networks (WAN), or other network topologies, equipment, or systems—including combinations thereof. Communication network 120 may be configured to communicate over metallic, wireless, or optical links. Communication network 120 may be configured to use time-division multiplexing (TDM), Internet Protocol (IP), Ethernet, optical networking, wireless protocols, communication signaling, peer-to-peer networking over Bluetooth, Bluetooth low energy, Wi-Fi Direct, near field communication (NFC), or some other communication format, including combinations thereof. In some examples, communication network 120 includes further access nodes and associated equipment for providing communication services to several computer systems across a large geographic region.

Application server 130 may be representative of any computing apparatus, system, or systems on which the techniques disclosed herein or variations thereof may be suitably implemented. Application server 130 comprises a processing system and communication transceiver. Application server 130 may also include other components such as a router, server, data storage system, and power supply. Application server 130 may reside in a single device or may be distributed across multiple devices. Application server 130 may be a discrete system or may be integrated within other systems, including other systems within communication system 100 or an automation control system. Some examples of application server 130 include desktop computers, server computers, cloud computing platforms, and virtual machines, as well as any other type of computing system, variation, or combination thereof. In some examples, application server 130 could comprise a programmable logic controller (PLC), programmable automation controller (PAC), network switch, router, switching system, packet gateway, authentication, authorization, and accounting (AAA) server, billing system, network gateway system, Internet access node, data server, database system, service node, firewall, or some other communication system, including combinations thereof. In some implementations, a PLC, PAC, and/or specific modules within the PLC rack could provide some or all of the functionality described herein for application server 130.

Communication links 121 and 131 use metal, air, space, optical fiber such as glass or plastic, or some other material as the transport medium—including combinations thereof. Communication links 121 and 131 could use various communication protocols, such as TDM, IP, Ethernet, telephony, optical networking, hybrid fiber coax (HFC), communication signaling, wireless protocols, or some other communication format, including combinations thereof. Communication links 121 and 131 could be direct links or may include intermediate networks, systems, or devices.

Turning now to FIG. 5, a block diagram that illustrates an industrial automation environment 500 in an exemplary implementation is shown. Industrial automation environment 500 provides an example of an industrial automation environment that may be utilized to implement the pinboard processes disclosed herein, but other environments could also be used. Industrial automation environment 500 includes computing system 510, machine system 520, industrial controller 525, database system 530, and application integration platform 535. Machine system 520 and controller 525 are in communication over a communication link, controller 525 and database system 530 communicate over a communication link, database system 530 and application integration platform 535 communicate over a communication link, and application integration platform 535 and computing system 510 are in communication over a communication link. Note that there would typically be many more machine systems in most industrial automation environments, but the number of machine systems shown in FIG. 5 has been restricted for clarity.

Industrial automation environment 500 comprises an automobile manufacturing factory, food processing plant, oil drilling operation, microprocessor fabrication facility, or some other type of industrial enterprise. Machine system 520 could comprise a sensor, drive, pump, filter, drill, motor, robot, fabrication machinery, mill, printer, or any other industrial automation equipment, including their associated control systems. A control system comprises, for example, industrial controller 525, which could include automation controllers, programmable logic controllers (PLCs), programmable automation controllers (PACs), or any other controllers used in automation control. Additionally, machine system 520 could comprise other industrial equipment, such as a brew kettle in a brewery, a reserve of coal or other resources, or any other element that may reside in an industrial automation environment 500.

Machine system 520 continually produces operational data over time. The operational data indicates the current status of machine system 520, such as parameters, pressure, temperature, speed, energy usage, operational equipment effectiveness (OEE), mean time between failure (MTBF), mean time to repair (MTTR), voltage, throughput volumes, times, tank levels, or any other performance status metrics. The operational data may comprise dynamic charts or trends, real-time video, or some other graphical content. Machine system 520 and/or controller 525 is capable of transferring the operational data over a communication link to database system 530, application integration platform 535, and computing system 510, typically via a communication network. Database system 530 could comprise a disk, tape, integrated circuit, server, or some other memory device. Database system 530 may reside in a single device or may be distributed among multiple memory devices.

Application integration platform 535 comprises a processing system and a communication transceiver. Application integration platform 535 may also include other components such as a router, server, data storage system, and power supply. Application integration platform 535 provides an example of application server 130, although server 130 could use alternative configurations. Application integration platform 535 may reside in a single device or may be distributed across multiple devices. Application integration platform 535 may be a discrete system or may be integrated within other systems—including other systems within industrial automation environment 500. In some examples, application integration platform 535 could comprise a FactoryTalk® VantagePoint server system provided by Rockwell Automation, Inc.

The communication links over which data is exchanged between machine system 520, industrial controller 525, database system 530, application integration platform 535, and communication interface 508 of computing system 510 could use metal, air, space, optical fiber such as glass or plastic, or some other material as the transport medium—including combinations thereof. The communication links could comprise multiple network elements such as routers, gateways, telecommunication switches, servers, processing systems, or other communication equipment and systems for providing communication and data services. These communication links could use various communication protocols, such as TDM, IP, Ethernet, telephony, optical networking, packet networks, wireless mesh networks (WMN), local area networks (LAN), metropolitan area networks (MAN), wide area networks (WAN), hybrid fiber coax (HFC), communication signaling, wireless protocols, communication signaling, peer-to-peer networking over Bluetooth, Bluetooth low energy, Wi-Fi Direct, near field communication (NFC), or some other communication format, including combinations thereof. The communication links could be direct links or may include intermediate networks, systems, or devices.

Computing system 510 may be representative of any computing apparatus, system, or systems on which the pinboard processes disclosed herein or variations thereof may be suitably implemented. Computing system 510 provides an example of a computing system that could be used as a either a server or a client device in some implementations, although such devices could have alternative configurations. Examples of computing system 510 include mobile computing devices, such as cell phones, tablet computers, laptop computers, notebook computers, and gaming devices, as well as any other type of mobile computing devices and any combination or variation thereof. Examples of computing system 510 also include desktop computers, server computers, and virtual machines, as well as any other type of computing system, variation, or combination thereof. In some implementations, computing system 510 could comprise a mobile device capable of operating in a server-like fashion which, among other uses, could be utilized in a wireless mesh network.

Computing system 510 includes processing system 501, storage system 503, software 505, communication interface 508, and user interface 509. Processing system 501 is operatively coupled with storage system 503, communication interface 508, and user interface 509. Processing system 501 loads and executes software 505 from storage system 503. Software 505 includes application 506 and operating system 507. Application 506 may include pinboard process 200 in some examples. When executed by computing system 510 in general, and processing system 501 in particular, software 505 directs computing system 510 to operate as described herein for pinboard process 200 or variations thereof. In this example, user interface 509 includes display system 511, which itself may be part of a touch screen that also accepts user inputs via touches on its surface. Computing system 510 may optionally include additional devices, features, or functionality not discussed here for purposes of brevity.

Turning now to FIG. 6, a block diagram is shown that illustrates computing system 600 in an exemplary implementation. Computing system 600 provides an example of computing systems 101 and 300, or any computing system that may be used to execute pinboard process 200 or variations thereof, although such systems could use alternative configurations. Computing system 600 includes processing system 601, storage system 603, software 605, communication interface 607, and user interface 609. User interface 609 comprises display system 608. Software 605 includes application 606 which itself includes pinboard process 200. Pinboard process 200 may optionally be implemented separately from application 606.

Computing system 600 may be representative of any computing apparatus, system, or systems on which application 606 and pinboard process 200 or variations thereof may be suitably implemented. Examples of computing system 600 include mobile computing devices, such as cell phones, tablet computers, laptop computers, notebook computers, and gaming devices, as well as any other type of mobile computing devices and any combination or variation thereof. Note that the features and functionality of computing system 600 may apply as well to desktop computers, server computers, and virtual machines, as well as any other type of computing system, variation, or combination thereof.

Computing system 600 includes processing system 601, storage system 603, software 605, communication interface 607, and user interface 609. Processing system 601 is operatively coupled with storage system 603, communication interface 607, and user interface 609. Processing system 601 loads and executes software 605 from storage system 603. When executed by computing system 600 in general, and processing system 601 in particular, software 605 directs computing system 600 to operate as described herein for pinboard process 200 or variations thereof. Computing system 600 may optionally include additional devices, features, or functionality not discussed herein for purposes of brevity.

Referring still to FIG. 6, processing system 601 may comprise a microprocessor and other circuitry that retrieves and executes software 605 from storage system 603. Processing system 601 may be implemented within a single processing device but may also be distributed across multiple processing devices or sub-systems that cooperate in executing program instructions. Examples of processing system 601 include general purpose central processing units, application specific processors, and logic devices, as well as any other type of processing device, combinations, or variations thereof.

Storage system 603 may comprise any computer readable media or storage media readable by processing system 601 and capable of storing software 605. Storage system 603 may include volatile and nonvolatile, removable and non-removable media implemented in any method or technology for storage of information, such as computer readable instructions, data structures, program modules, or other data. Storage system 603 may be implemented as a single storage device but may also be implemented across multiple storage devices or sub-systems co-located or distributed relative to each other. Storage system 603 may comprise additional elements, such as a controller, capable of communicating with processing system 601. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the storage media a propagated signal.

In operation, in conjunction with user interface 609, processing system 601 loads and executes portions of software 605, such as pinboard process 200, to render a graphical user interface for application 606 for display by display system 608 of user interface 609. Software 605 may be implemented in program instructions and among other functions may, when executed by computing system 600 in general or processing system 601 in particular, direct computing system 600 or processing system 601 to display a pinboard associated with an asset of an industrial automation environment on display system 608 of computing system 600, wherein the pinboard includes a plurality of entries comprising content associated with the asset. In addition, software 605 directs computing system 600 or processing system 601 to receive a user request to add to the pinboard a new entry comprising additional content associated with the asset. Finally, software 605 may direct computing system 600 or processing system 601 to transfer the user request to an application server, wherein the application server processes the user request to add the new entry to the pinboard.

Software 605 may include additional processes, programs, or components, such as operating system software or other application software. Examples of operating systems include Windows®, iOS®, and Android®, as well as any other suitable operating system. Software 605 may also comprise firmware or some other form of machine-readable processing instructions executable by processing system 601.

In general, software 605 may, when loaded into processing system 601 and executed, transform computing system 600 overall from a general-purpose computing system into a special-purpose computing system customized to facilitate pinning information in an industrial automation environment as described herein for each implementation. For example, encoding software 605 on storage system 603 may transform the physical structure of storage system 603. The specific transformation of the physical structure may depend on various factors in different implementations of this description. Examples of such factors may include, but are not limited to the technology used to implement the storage media of storage system 603 and whether the computer-readable storage media are characterized as primary or secondary storage.

In some examples, if the computer-readable storage media are implemented as semiconductor-based memory, software 605 may transform the physical state of the semiconductor memory when the program is encoded therein. For example, software 605 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 600 is generally intended to represent a computing system with which software 605 is deployed and executed in order to implement application 606 and/or pinboard process 200 (and variations thereof). However, computing system 600 may also represent any computing system on which software 605 may be staged and from where software 605 may be distributed, transported, downloaded, or otherwise provided to yet another computing system for deployment and execution, or yet additional distribution. For example, computing system 600 could be configured to deploy software 605 over the internet to one or more client computing systems for execution thereon, such as in a cloud-based deployment scenario.

Communication interface 607 may include communication connections and devices that allow for communication between computing system 600 and other computing systems (not shown) or services, over a communication network 611 or collection of networks. In some implementations, communication interface 607 receives dynamic data 621 over communication network 611. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 609 may include a voice input device, a touch input device for receiving a gesture from a user, a motion input device for detecting non-touch gestures and other motions by a user, and other comparable input devices and associated processing elements capable of receiving user input from a user. Output devices such as display system 608, speakers, haptic devices, and other types of output devices may also be included in user interface 609. The aforementioned user input devices are well known in the art and need not be discussed at length here. User interface 609 may also include associated user interface software executable by processing system 601 in support of the various user input and output devices discussed above. Separately or in conjunction with each other and other hardware and software elements, the user interface software and devices may provide a graphical user interface, a natural user interface, or any other kind of user interface.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated drawings teach the best mode of the invention. The following claims specify the scope of the invention. Some aspects of the best mode may not fall within the scope of the invention as specified by the claims. Also, while the preceding discussion describes embodiments employed specifically in conjunction with the monitoring and analysis of industrial processes, other applications, such as the mathematical modeling or monitoring of any man-made or naturally-existing system, may benefit from use of the concepts discussed above. Further, those skilled in the art will appreciate that the features described above can be combined in various ways to form multiple variations of the invention. As a result, the invention is not limited to the specific embodiments described above, but only by the following claims and their equivalents.

What is claimed is:

1. One or more computer-readable storage media having program instructions stored thereon to facilitate pinning information in an industrial automation environment, wherein the program instructions, when executed by a computing system, direct the computing system to at least:
display a pinboard associated with an asset of the industrial automation environment on a display system of the computing system, wherein the pinboard includes a plurality of entries comprising content associated with the asset;
receive a user request to add to the pinboard a new entry comprising additional content associated with the asset; and
transfer the user request to an application server, wherein the application server processes the user request to add the new entry to the pinboard.

2. The one or more computer-readable storage media of claim 1 wherein the asset of the industrial automation environment comprises an industrial control system.

3. The one or more computer-readable storage media of claim 2 wherein the content associated with the asset comprises tag data received from the industrial control system.

4. The one or more computer-readable storage media of claim 1 wherein the user request to add to the pinboard the new entry comprising the additional content associated with the asset comprises a request to automatically add to the pinboard the new entry comprising the additional content upon an occurrence of an event trigger associated with the asset.

5. The one or more computer-readable storage media of claim 1 wherein the program instructions direct the computing system to display the pinboard associated with the asset of the industrial automation environment on the display system of the computing system by directing the computing system to filter the entries comprising the content associated with the asset by a category.

6. The one or more computer-readable storage media of claim 1 wherein the user request to add to the pinboard the new entry comprising the additional content associated with the asset comprises instructions to assign security permissions to the new entry comprising the additional content.

7. The one or more computer-readable storage media of claim 1 wherein the program instructions further direct the computing system to store the new entry comprising the additional content in a local storage system of the computing system, and responsive to a request to view the additional content when the computing system is not in communication with the application server, retrieve the additional content from the local storage system and display the additional content on the display system.

8. A method of operating a computing system to facilitate pinning information in an industrial automation environment, the method comprising:
accessing a pinboard associated with an asset of the industrial automation environment;
receiving pinboard content comprising a plurality of data items associated with the asset;
displaying the pinboard on a display system of the computing system, wherein the pinboard comprises the pinboard content comprising the plurality of data items associated with the asset;
receiving a user request to add additional content associated with the asset to the pinboard; and
transferring the user request to an application server, wherein the application server processes the user request to add the additional content to the pinboard.

9. The method of claim 8 wherein the asset of the industrial automation environment comprises an industrial control system.

10. The method of claim 9 wherein the pinboard content comprising the plurality of data items associated with the asset comprises tag data received from the industrial control system.

11. The method of claim 8 wherein the user request to add additional content associated with the asset to the pinboard comprises a request to automatically add the additional content associated with the asset to the pinboard upon an occurrence of an alarm event associated with the asset.

12. The method of claim 8 wherein displaying the pinboard comprising the pinboard content on the display system comprises filtering the pinboard content comprising the plurality of data items associated with the asset by a category.

13. The method of claim 8 wherein the user request to add the additional content associated with the asset to the pinboard comprises instructions to assign security permissions to the additional content.

14. The method of claim 8 further comprising storing the additional content in a local storage system of the computing system, and responsive to a request to view the additional content when the computing system is not in communication with the application server, retrieving the additional content from the local storage system and displaying the additional content on the display system.

15. An apparatus to facilitate pinning information in an industrial automation environment, the apparatus comprising:
one or more computer-readable storage media; and
program instructions stored on the one or more computer-readable storage media that, when executed by a processing system, direct the processing system to at least:
display a graphical user interface (GUI) on a display system of a computing system, wherein the GUI includes a pinboard comprising content associated with an asset of the industrial automation environment;
receive a user request to add additional content associated with the asset to the pinboard; and
transfer the user request to an application server, wherein the application server processes the user request to add the additional content to the pinboard.

16. The apparatus of claim 15 wherein the asset of the industrial automation environment comprises an industrial control system.

17. The apparatus of claim 16 wherein the content associated with the asset comprises tag data received from the industrial control system.

18. The apparatus of claim 15 wherein the user request to add the additional content associated with the asset to the pinboard comprises a request to automatically add the additional content to the pinboard upon an occurrence of an alert associated with the as set.

19. The apparatus of claim 15 wherein the program instructions direct the processing system to display the GUI including the pinboard on the display system of the computing system by directing the processing system to filter the content associated with the asset of the industrial automation environment by a category.

20. The apparatus of claim 15 wherein the user request to add the additional content associated with the asset to the pinboard comprises instructions to assign security permissions to the additional content.
